(19) United States
(12) Patent Application Publication
(10) Pub. No.: US 2008/0189432 A1
(43) Pub. Date: Aug. 7, 2008

(54) METHOD AND SYSTEM FOR VM MIGRATION IN AN INFINIBAND NETWORK

(75) Inventors: Bulent Abali, Tenafly, NJ (US); Jiuxing Liu, White Plains, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/670,490

(22) Filed: Feb. 2, 2007

(51) Int. Cl. G06F 15/173

(52) U.S. Cl. 709/238

(57) ABSTRACT

A virtual machine (VM) is migrated from a physical source node to a physical destination node in an InfiniBand network. A virtual host channel adapter (VHCA) is allocated on the source node for the VM to be migrated. The VHCA is suspended and put into the inactive state. The state information of the VM, including VHCA state information, is saved in a location-transparent manner. The state information is transferred from the source node to the destination node. A new VM is created, and a VHCA is allocated for the new VM on the destination node. The state information is transferred from the source node, including the VHCA state information. The routing and switching information is updated, operation of the VM is resumed, and the VHCA is put into an active state.

### BACKGROUND

This application relates to migration in a network, in particular VM migration in an InfiniBand network.

Virtual Machine (VM) technologies were first introduced in the 1960s. Recently, they have been experiencing resurgence in both industry and academia. VM checkpoint/restart and migration are important tools to improve system reliability, availability, and serviceability.

InfiniBand architecture is a high speed interconnected network based on an industry standard. It offers very good performance with bandwidths in the order of 10 Gbps and latencies that are less than 10 microseconds for small messages. In the past few years, InfiniBand has become a strong player in the area of high performance computers (HPC), where I/O and communicating performance is essential. More recently, it has also been introduced to high-end enterprise systems as an interconnect for networking, clustering, and storage. More details of InfiniBand architecture may be found at http://www.infinibandta.org/specs/.

InfiniBand Host Channel Adapters (HCAs) are similar to network interface cards (NICs) in traditional networks. The InfiniBand communication stack includes many layers. The interface presented by HCAs to consumers belongs to the transport layer. A queue-based model is used in this interface. A Queue Pair (QP) in the InfiniBand architecture includes a send queue and a receive queue. The send queue holds instructions to transmit data, and the receive queue holds instructions that describe where received data is to be placed. Communication operations are described in Work Queue Requests (WQR), or descriptors, and submitted to the QPs. Once submitted, a WQR becomes a Work Queue Element (WQE) and is executed by an HCA. The completion of InfiniBand communication is reported through Completion Queues (CQs) by Completion Queue Entries (CQEs). An application can subscribe for notification from an HCA and register a callback handler with a CQ. Complete queues can also be accessed through polling to reduce latency.

Initiating data transfer (posting work requests) and completion of work requests notification (polling for completion) are time-critical tasks which use OS-bypass. One approach for performing these operations is described in detail at http://www.mellanox.com.

InfiniBand architecture also provides a comprehensive management scheme. Management communication is achieved by sending datagrams (MADs) to well known QPs (e.g., QP0 and QP1).

InfiniBand architecture requires all buffers involved in communication to be registered before they can be used in data transfer. The purpose of registration is two-fold. First, an HCA need to keep an entry in the Translation and Protection Table (TPT) so that it can perform virtual-to-physical translation and protection checks during data transfer. Second, the memory buffer needs to be pinned in memory so that the HCA can DMA directly into the target buffer. Upon success of the registration, a local key and a remote key are returned. They will be used later for local and remote (RDMA) accesses.

It has been shown that direct access of InfiniBand devices inside VMs without involvement of a Virtual Machine Monitor (VMM) can greatly improve system I/O performance. Therefore, it is important to provide checkpoint/restart and migration support for VMs that use InfiniBand. However, the direct access (VMM-bypass) approach of Infiniband in VMs poses challenges for implementing transparent checkpoint/restarting and migration of VMs. This is due to the fact that intelligent devices, such as InfiniBand devices, support direct access and maintain a great deal of state information to support their functionalities. This presents several obstacles.

One major obstacle is that there is no support in current InfiniBand networks for portable network addresses. In an InfiniBand network, ports in InfiniBand Host Channel Adapter (HCAs) are identified using local IDs (LIDs) or global IDs (GIDs). However, most current Infiniband HCAs only support a single LID or GID per port. As a result, all virtual InfiniBand devices in guest VMs share the same network address. Thus, when a virtual InfiniBand device migrates to another node, its address will have to change, which breads transparency. The InfiniBand Specification provides a mechanism called LID mask control (LMC) which can provide multiple LIDS for a single port. However, it does not allow an LID to migrate from one node to another.

Another obstacle to transparent checkpoint/restart and migration of VMs is that there is no easy way to selectively suspend/resume communications. Since InfiniBand devices support OS-bypass or VMM-bypass communication, applications directly access hardware without going through the VMM. Furthermore, RDMA operation in an InfiniBand network allows a remote client to directly access host memory without the VMM or the OS being aware of it. Therefore, it it hard for the VMM to stop or buffer ongoing communication unless the InfiniBand hardware provides such a mechanism. This poses difficulties for checkpoint/restart and migration because RDMA operations may result in memory corruption if they are not handled carefully. Furthermore, partially complete communication operations are difficult to handle, and extra information is needed to track them. It would also be desirable to be able to only selectively suspend/resume communication with a particular virtual device instead of a whole physical device. Unfortunately, current InfiniBand hardware does not provide such support.

Another obstacle is that there is no state information management mechanism in current InfiniBand networks. The direct access model of virtual InfiniBand also means that the HCA hardware needs to store a lot of state information. InfiniBand HCAs typically manage information, such as that related to QPs and CQs. The information can be stored in HCA on-board memory or in host main memory. In order to support checkpointing and migration, there needs to be a mechanism for reading and updating HCA state information. However, current InfiniBand HCAs do not provide such a mechanism. Currently, only part of the HCA's state information is exposed to software through the InfiniBand VERBS interface, and the state information is only updated as a side effect of certain VERBS function calls. As a result, currently it is not possible to restore a virtual InfiniBand device directly to an arbitrary state.

Yet another obstacle is posed by location-dependent resource handles. In InfiniBand networks, software (applications or OSs) use opaque handles to access HCA resources. For example, QP number and CQ numbers are used for accessing QP and CQ, respectively, and local or remote memory keys are used to specify communication buffers. Since the meanings of the handles are opaque to software, the hardware can store certain information in them to facilitate its implementation. For example, an HCA may use a global table to store information about all QPs. To speed up QP entry lookup, it may use part of the QP number to store the QP table entry index. However, when a virtual HCS is migrated to another node, the corresponding QP table entries may already be occupied in the HCA of the new node. This will force the migrating QPs to change their handles (also known as QP numbers) and result in breaking of transparency. Therefore, these kinds of resource handles are location-dependent and should be avoided for the purpose of transparent checkpoint/restart and migration. Unfortunately, they are used in current InfiniBand HCAs.

InfiniBand also offers RDMA to enable a remote client to access the memory address spaces of a local process. In this feature, a remote key is obtained by registering a memory buffer with the HCA. The remote key is then transferred to the remote client who can later access the memory buffer by presenting the key. Similar to HCA resources being available to local software, remote keys must not be location-dependent in order to make checkpoint/restart and migration transparent to remote clients.

There have been very few attempts at addressing checkpoint/restart and migration issues of InfiniBand networks. Several past projects that implemented checkpoint/restart for InfiniBand and other similar devices had to free all device resources before checkpointing and reallocating when restarting. These approaches have high overhead and do not maintain transparency.

### SUMMARY

According to exemplary embodiments, a method and system are provided for migrating a virtual machine (VM) from a physical source node to a physical destination node in an InfiniBand network. A virtual host channel adapter (VHCA) is allocated on the source node for the VM to be migrated. The VHCA is suspended and put into the inactive state. The state information of the VM, including VHCA state information, is saved in a location-transparent manner. The state information is transferred from the source node to the destination node, including the VHCA state information. A new VM is created, and a VHCA is allocated for the new VM on the destination node. The routing and switching information is updated, operation of the VM is resumed, and the VHCA is put into an active state.

Additional features and advantages are realized through the techniques of the present invention. Other embodiments and aspects described in detail herein and are considered a part of the claimed subject matter. For a better understanding of the claimed subject matter with advantages and features, refer to the description and to the drawings.

### BRIEF DESCRIPTION OF DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates conventional InfiniBand HCA architecture;

FIG. 2 illustrates InfiniBand HCA architecture according to an exemplary embodiment.

FIG. 3 illustrates an exemplary method for migrating a VM according to an exemplary embodiment.

The detailed description explains exemplary embodiments of the invention, together with advantages and features, by way of example with reference to the drawings.

### DETAILED DESCRIPTION OF EMBODIMENTS

According to exemplary embodiments, InfiniBand checkpoint/restart and migration are supported as an extension of current InfiniBand hardware and software through the use of virtual HCAs (VHCAs). VHCAs not only encapsulate the information needed for checkpoint/restart and migration but also serve as the basic units for these operations.

At the software level, VHCAs can be represented by opaque handles. To support transparent checkpoint and migration, the value of a VHCA handle is not location dependent. Unlike a physical HCA, VHCAs can be dynamically created and destroyed. Exemplary functions for creating and destroying a VHCA may include:

int creat_vhca(vhca_handle*,vhca_properties);

int destroy_vhca(vhca_handle); It should be noted that the functions above are just examples. Actual implementation may follow the same idea but use different interfaces.

According to exemplary embodiments, these functions return a code to indicate whether the function is successfully executed or not. To create a VHCA, a set of VHCA properties may be provided that must be met. If a particular implementation does not support the use of VHCAs, it can return the corresponding error code in the create _vhca function.

VHCAs may be in one of two state: active and inactive. During communication and other normal InfiniBand operation, a VHCA is considered to be in the active state. In the inactive state, several checkpoint/restart and migration operations can be performed on a VHCA. However, when in this state, a VHCA will return an error for normal InfiniBand operations. It will also suspend any incoming communication traffic by dropping the messages or buffering them. Examples of functions for changing the state of a VHCA are shown below:

int suspend_vhca(vhca_handle);

int resume _vhca(vhca_handle);

The idea of introducing an inactive state is to allow a VHCA to be put into a state which is easy for checkpoint/restart and migration. Besides suspending communication, an acutal implementation can also perform other tasks, such as flushing or invalidating certain internal state information. The functions for suspending and resuming VHCAs can either be synchronous (as shown above) or asynchrous (by returning the status of the operation using a callback function).

According to an exemplary embodiment, each VHCA can have its own InfiniBand addrss. The following two functions may be used to assign and unassign an address to a VHCA:

int assign_vhca_address(vhca_handle, ib_address);

int assign_vhca_any_address(vhca_handle,*ib address);

int unassign_vhca_addresses(vhca_handle);

The first function assigns a predefined address to a VHCA. The second function asks the HCA to assign itself an arbitrary address. The HCA can pick any address that is convenient for its implementation. It should be noted that they must be called when a VHCA is inactive. Otherwise, an error code will be returned. The function can also be extended to accommodate the cases where a VHCA has multiple ports (hence, multiple addresses).

To enable checkpoint/restart and migration for a VHCA, the state information of the VHCA must manipulated. When in the inactive state, a VHCA supports a function, such as the following:

int save_vhca_sate(vhca_handle, output);

int restore _vhca_state(vhca_handle, input);

The first function saves all the state information related to a VHCA to “output”, and the second function restore a VHCA to a state determined by the parameter “input”. The actual form of “output” and “input” depends on the implementation. For example, they may include a file descriptor or a memory address.

According to an exemplary embodiment, there are two ways to represent state information. The first uses a native format. In this implementation, the content of parameters “input” and “output” is opaque to software and only understood by a particular kind of HCA hardware. An advantage of using a native format is fast saving or restoring of VHCA states. For example, an HCA may use memory to share all the state information related to VHCAs, and it can use simple memory copy operations for the above functions. Additionally, a native format can result in smaller size of state information, because an HCA can tailor the information to its implementation. However, a native format only works for HCAs of the same type (or HCAs which support the same type of native formats). The second way to represent state information is to use an implementation-independent format. In this implementation, the format of the state information is predefined and platform-neutral. Because the HCA hardware may need to carry out translation between a native format and the implementation-independent format, saving or restoring state information may take longer. However, it enables checkpoint/restart and migration between different types of HCAs.

It should be noted that regardless of whether a native format or an implementation-independent format is used, the VHCA state information needs to be represented in a location-transparent way. Otherwise, the state information may no be valid any more when restored on a different physical HCA.

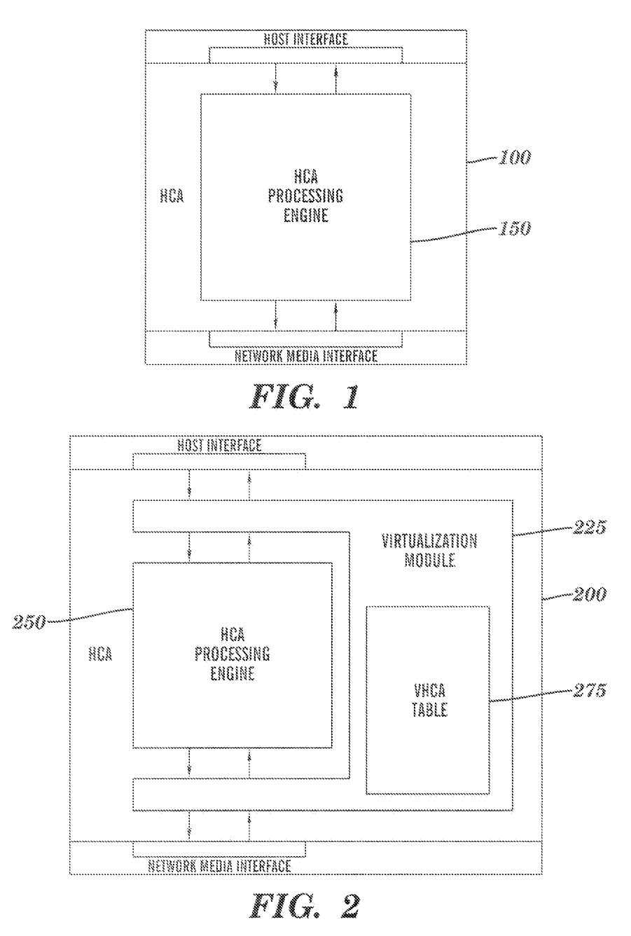

As explained above, the VHCA interface according to exemplary embodiments may be implemented by changing or extending current InfiniBand HCA architecture. To understand how this can be achieved, it is helpful to explain the current Infiniband HCA, illustrated in FIG. 1. The core part of an HCA 100 is the HCA processing engine 150, which is in charge of processing commands coming from the host through the host interface and packets coming from the network from the network media interface. Although not shown in the interest of simplicity of illustration, the HCA processing engine may also contain other components, such as DMA engines.

Traditionally, InfiniBand HCAs store all information using global data structures. For example, an HCA may use a single table to store information about all CQs. However, supporting VHCAs requires an Infiniband to tack all resources associated with a particular VHCA. One possible way to achieve this is to use a separate data structure for each VHCA. However, this may result in a much more complicated HCA design. According to an exemplary embodiment, another way is to introduce a new VHCA table while keeping global data structure. The VHCA table tracks resources associated with each VHCA and can be used for access checks and checkpoint/restart and migration operations.

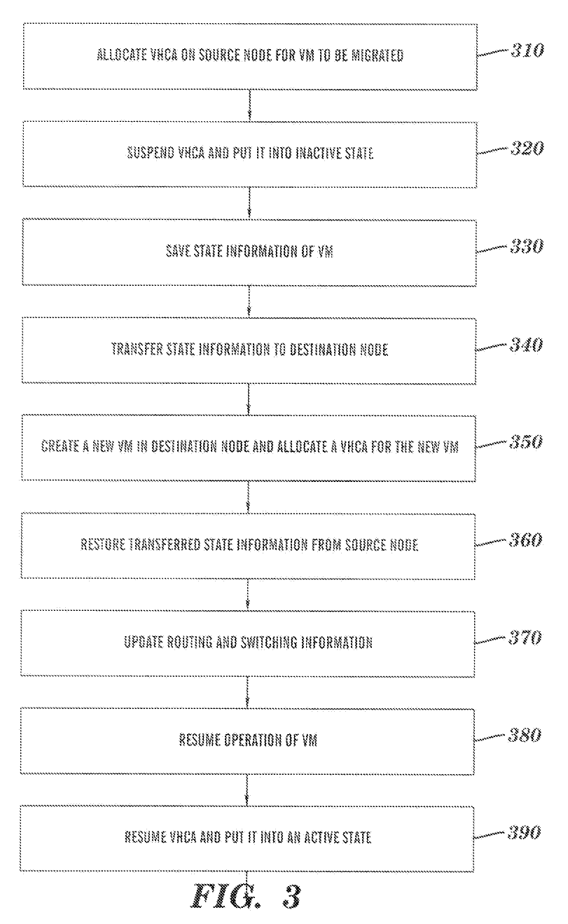

To support checkpoint/restart and migration in a VM environment, a new component, called a virtualization module, is provided in an HCA structure 200, as shown in FIG. 2. Host commands and incoming packets first go through the virtualization module 225 instead of the HCA processing engine 250. The virtualization module 225 utilizes a VHCA table 275 to keep track of information about different VHCAs. The virtualization module 225 can be implemented by hardware or firmware. It may also be implemented using software, provided that packet and command processing is done in software in the current HCA implementation.

According to exemplary embodiments, each VHCA has its own InfiniBand address, and this information can be stored in the VHCA table. For each outgoing InfiniBand packet, the source address is retrieved from the corresponding VHCA table. For each incoming packet, the VHCA table is located first base on destination address, and then it is used to validate the packet.

When supporting multiple addresses for a single HCA, correct routing and switching information needs to be set up in the InfiniBand network. This can be achieved via the help of Infiniband subnet managers. To avoid contacting the subnet manager each time a VHCA is allocated, an HCA can pre-allocate a block of addresses and cache unassigned addresses for later use.

Since the virtualization module controls both the network media interface and the host interface, it can suspend or resume a VHCA easily. Suspending a VHCA temporarily stops both is local operations (except for the several VHCA related functions introduced) and incoming communication traffic. However, the HCA is not required to respond to the suspension request immediately. Therefore, it can wait for all ongoing communication (both incoming and outgoing) to finish before suspending the VHCA. In this way, the HCA does not have to worry about partially completed communication operations. It can perform other internal operation also. For example, if VHCA state information is stored in memory, and a cache is used in the HCA to speed up the look-up, it can flush the cache so that the information in the memory is up-to-date.

As mentioned earlier, VHCA state information needs to be saved in a location-transparent way so that it can be restored later in a different physical HCA. There are many ways to achieve this goal. In one approach, VHCA state information includes a table of multiple entries. An entry in the state information table represents a certain instance of a VHCA resource. Each entry may contain the following subfields: resource type, local state information, and relationship to other resourced instances. Examples of the resource type subfield may include global information associated with the VHCA, queue pair (QP), completion queue (CQ), register memory, protection document (PD), etc. The local state information subfield may store the properties of the resource instance. For example, an instance of a QP resource may contain properties, such as QP number, QP state, etc. The other resource instances subfield may contain information regarding related InfiniBand resources. For example, CQs are usually used by QPs to inform the software about the completion of communication operations. For implementing CQs and QPs, registered memory buffers are usually used to store CQ and QP entries. This field stores references to other resource instances which represent their relationship to the current resource instance. References to other resource instances can be represented by the respective index in the state information table.

It should be noted that not all state information related to a VHCA needs to be stored. Basically, state information which is visible to outside (software or remote) clients needs to be preset in the state information table, as well as information which is necessary to reconstruct all the resource instances. Other implementation specific internal state may be omitted.

As mentioned earlier, in order to support transparent checkpoint/restart and migration, handles for HCA resources which are visible to either local software (applications or OSs) or remote clients must be location-transparent. Unfortunately, in order to simplify implementation, current HCA address implementations use location-dependent handles. According to exemplary embodiments, for these implementations, a translation table can be added to the HCA hardware which basically “virtualizes” existing resource handles to make them location-transparent. For example, a “virtualized ” QP number can be obtained by combing the VHCA handle (which is location-transparent) and an index number which is only valid in the context of the current VHCA. When software accesses a QP, the relation table located in the HCA hardware can be used to obtain the location-dependent version of the QP number. The translation table may also be used when resources accessed are from remote clients, as in the case of RDMA. This table can be part of the VHCA state table described above.

To understand VM migration according to exemplary embodiments, consider a scenario in which a virtual InfiniBand interface is migrated from one machine to another. An exemplary flowchart depicting a process for this scenario is illustrated in FIG. 3. In this scenario, a VM is migrating from one physical node to another. Assume that the nodes (the source node and the destination node) are equipped with InfiniBand HCAs that implement checkpoint/restart and migration support described above. Also assume that both nodes are in the same InfiniBand subnet.

In this scenario, the migration includes the following steps. Before migration (when the VM is created), the VMM on the source node allocates a VHCA for the VM to be migrated at step 310. When the migration starts, the VMM suspends the VHCA and puts it into the inactive state at step 320. At step 330, the VMM saves the state information of the VM, including VHCA state information, which can be obtained through the interface described above. The state information is transferred to the destination node at step 340. The VMM on the destination node creates a new VM and allocates a VHCA for the new VM at step 350. The VMM restores the state information transferred from the source node (including the VHCA state information) at step 360. The InfiniBand subnet manager is contacted to update routing and switching information at step 370. The VMM then resumes the VM at step 380. The VHCA is also resumed and put into the active state at step 390.

The proposed InfiniBand HCA support for checkpoint/restart and migration may also be useful even when an HCA is not shared by multiple VMs. Consider the following scenarios.

In a first scenario, a checkpoint/restart and migration process is used in an environment that is not a VM environment. To support this case, a VHCA can be allocated to the process that is to be checkpointed or migrated. If the checkpoint/restart or migration process involves several processes, they can share the same VHCA. The OS kernel is responsible for managing the allocated VHCAs.

In a second scenario, a VM environment is used. However, instead of sharing the physical InfiniBand HCA among multiple VMs, it is dedicated to a single VM which will later be checkpointed or migrated. This case may be handled as described above. However, to support this case, only a subset of the modifications described above is needed. For example, there is no need for virtual HCA resource handles to support multiple InfiniBand addresses.

The embodiments described above can be embodied in the form of computer-implemented processes and apparatuses for practicing those processes. Exemplary embodiments may be implemented in computer program code executed by one or more network elements. Embodiments include computer program code containing instructions embodied in tangible media, such as floppy diskettes, CD-ROMs, hard drives, or any other computer-readable storage medium wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc., do not denote any order or importance, but rather the terms first, second, etc. are used to distinguish one element from another. Furthermore, the use of the terms a, an, etc., do not denote a limitation of quantity, but rather denote the presence of at least one of the referenced item.

We claim:

1. A method for migrating a virtual machine (VM) from a physical source node to a physical destination node in an InfiniBand network, the method comprising:
allocating on the source node a virtual host channel adapter (VHCA) for the VM to be migrated;
suspending the VHCA and putting the VHCA into the inactive state;
saving the state information of the VM, including VHCA state information, wherein the VHCA state information is stored in a location-transparent manner in the source node;
transferring the state information from the source node to the destination node,
creating a new VM and allocating a VHCA for the new VM on the destination node;
restoring the state information transferred from the source node, including the VHCA state information;
updating routing and switching information;
resuming operation of the VM; and
putting the VHCA into an active state.

2. The method of claim 1, wherein the VHCA state information includes information regarding instances of VHCA resources, including resource type, local state information, and relationships to other VHCA resources.

3. A system for migrating a virtual machine (VM) from a physical source node to a physical destination node in an InfiniBand network, the system including:
a source node including a host channel adapter (HCA) having a virtualization module; and
a destination node including an HCA having a virtualization module, and
an InfiniBand subnet manager;
wherein for migrating the VM from the source node to the destination node, the virtualization module in the source node allocates a virtual host channel adapter (VHCA) for the VM to be migrated, suspends the VHCA and puts the VHCA into an inactive state, saves the state information of the VM, including state information, in a location-transparent manner, and transmits the state information to the destination node, and wherein the virtualization module in the destination node creates a new VM, allocates a VHCA for the VM, restores the state information transferred from the source node, including the VHCA state information, contacts the InfiniBand subnet manger for updating routing and switching information; resumes operation of the VM, and puts the VHCA in the destination node into an active state.

4. The system of claim 3, wherein the VHCA state information includes information regrading instances of VHCA resources, including resource type, local state information, and relationships to other VHCA resources. _
